(19) United States
(12) Patent Application Publication
(10) Pub. No.: US 2013/0245894 A1
(43) Pub. Date: Sep. 19, 2013

(54) DRIVER ASSISTANCE SYSTEM

(71) Applicant: GM GLOBAL TECHNOLOGY OPERATIONS LLC, Detroit, MI (US)

(72) Inventors: Johannes HUTH, Frankfurt (DE); Christian Rudolf JERUSALEM, Ruesselsheim (DE); Gerald SCHMIDT, Frankfurt am Main (DE)

(73) Assignee: GM GLOBAL TECHNOLOGY OPERATIONS LLC, Detroit, MI (US)

(21) Appl. No.: 13/777,157

(22) Filed: Feb. 26, 2013

(30) Foreign Application Priority Data
Mar. 13, 2012 (DE) 10 2012 005 074.7

(51) Int. Cl. B60R 21/013

(52) U.S. Cl. CPC B60R 21/013
USPC 701/45

(57) ABSTRACT

A driver assistance system for a motor vehicle encompasses at least one foot sensor for monitoring the foot of a driver, a control unit for deciding on a safety measure based on a detection result of the foot sensor, and an environmental sensor to detect an approach toward an outside obstacle, and is set up to only implement the safety measure if a detection result of the environmental sensor indicates a danger that contact will be made with the obstacle.

### CROSS-REFERENCE TO RELATED APPLICATION

This application claims priority to German Patent Application No. 10 2012 005 074.7, filed Mar. 13, 2012, which is incorporated herein by reference in its entirety.

### TECHNICAL FIELD

The technical field relates to a driver assistance system for a motor vehicle, which assists the driver in recognizing dangerous situations and implementing safety measures to avert a danger.

### BACKGROUND

Such a driver assistance system should ideally only take action if the driver fails to perceive a danger or does not respond to it in an adequate manner. In order to meet this objective, such a driver assistance system should not only have the necessary sensors to be able to detect that a dangerous situation is objectively present, but should also be able to monitor the driver and, in a dangerous situation, assess whether the driver is adequately responding to the danger. Since such an adequate response most often encompasses braking the vehicle, such a driver assistance system should therefore be able to monitor a foot of the driver and assess whether the latter is pressing on the brake pedal or just about to do so.

Known from DE 10 2007 003 740 A1 is a driver assistance system with a brake control system, which, in order to monitor the driver's foot, exhibits a first sensor that detects a rearward motion of the brake pedal or a rearward motion of the driver's foot on the gas pedal, and a second pressure-sensitive sensor on the floor of the foot well, which is intended to recognize a movement by the foot from the gas pedal to the brake pedal, and assume an emergency braking situation exists if it is detected that the retraction of the foot from the gas pedal is also accompanied by a movement in the direction of the brake pedal.

Since this conventional driver assistance system has absolutely no information sources that enable it to ascertain the reasons for the movement of a driver's foot from the gas pedal to the brake pedal, there is a high risk that an emergency braking situation will not be recognized, or its presence will be mistakenly assumed. As long as the driver does not actually press the brake, there are no reliable indications that enable this conventional driver assistance system to differentiate between a foot motion performed by the driver with the direct intention of braking and a movement in which the driver merely places his or her foot over the brake pedal so that he or she can brake immediately if needed. If the assistance system mistakenly assumes an emergency braking situation in the latter case, and initiates a deceleration before the driver has actually touched the brake pedal, it can be extremely irritating to the driver, and cause him or her not to use such an assistance system, even though it objectively provides for an increase in safety.

Therefore, at least one object herein is to provide a driver assistance system that is able to reliably initiate a safety measure only when it is really necessary. In addition, other objects, desirable features and characteristics will become apparent from the subsequent summary and detailed description, and the appended claims, taken in conjunction with the accompanying drawings and this background.

### SUMMARY

In an exemplary embodiment, a driver assistance system with at least one foot sensor for monitoring a driver's foot and a control unit for deciding on a possible safety measure based on a detection result of the foot sensor is provided and further encompasses an environmental sensor to detect an approach toward an outside obstacle. The driver assistance system is set up to only implement the safety measure if a detection result of the environmental sensor indicates a danger that contact will be made with the obstacle. If there is no objective danger that contact will be made with the obstacle, then it can also not be assumed that a movement of the driver's foot detected by the foot sensor indicates the immediate intention of the driver to apply the brakes. It may sooner involve an anticipatory measure having as its objective to counter a potentially imminent danger in time. In such a case where a danger does not yet objectively exist, the driver assistance system as contemplated herein can prevent an anticipatory initiation of the safety measure.

Specifically, a control unit is set up to quantitatively assess the risk of contact with the obstacle based on the detection result of the environmental sensor, e.g., by estimating a residual time remaining until potential contact with the obstacle, and implement the safety measure at a prescribed risk level when the detection result of the foot sensor indicates that the driver is unprepared to brake, or to forego the safety measure if the detection result of the foot sensor indicates that the driver is prepared to brake.

In an exemplary embodiment, another high danger level can best be defined above this prescribed level, so that once this high level has been reached, the safety measure is introduced without regard to the detection result of the foot sensor.

In particular, the foot sensor can encompass a camera facing the air space in front of the tread of the brake pedal, preferably an infrared camera, and/or a contactless sensor mounted on the brake pedal, in particular on its tread.

In particular an infrared sensor, an ultrasound sensor or a capacitive sensor is possible as such a contactless sensor.

The limiting value above which the driver assistance system initiates the safety measure can vary depending on the detection result of the foot sensor. This makes it possible in particular to take into account different degrees of certainty with which a detected foot movement points to the attentiveness and braking preparedness of the driver when deciding on the safety measure.

In an embodiment, the safety measure involves activating the brake of the motor vehicle or outputting a warning signal to the driver. A driver assistance system as contemplated herein can also implement both safety measures, if necessary based upon respectively different limiting values when deciding on whether to initiate the measure.

In another embodiment, the threshold starting at which the safety measure is initiated is higher when the foot sensor detects a body than when it does not detect a body. If a body, in particular a foot, is detected in front of the brake pedal, it can be concluded that the driver is prepared to press the brake, and that a safety measure initiated by the driver assistance system will sooner irritate rather than assist the driver under these circumstances.

One especially informative indicator for the attentiveness of the driver is when the foot sensor starts to detect a body only after detecting the outside obstacle. If this is the case, it can be concluded that the driver has also perceived the obstacle, and has put his or her foot on the brake so as to be able to decelerate quickly if needed. Once again, the driver assistance system should not anticipate the driver in this type of situation.

In addition, the foot sensor can be set up to estimate how fast the body is moving, wherein a threshold starting at which the safety measure is initiated is set depending on how fast the body is moving. On the one hand, a very low speed may point to a random movement of the foot not induced by the traffic conditions, so that a low initiation threshold for the safety measure makes sense in this instance. On the other hand, however, an extremely high speed may indicate a startle response by the driver, so that a relatively low threshold for initiating a braking action would make sense here as well.

### BRIEF DESCRIPTION OF THE DRAWINGS

The various embodiments will hereinafter be described in conjunction with the following drawing figures, wherein like numerals denote like elements, and wherein:

FIG. 1 is a schematic view in the foot well of a motor vehicle according to an exemplary embodiment; and

FIG. 2 is a flowchart for a working method of the driver assistance system according to an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

The driver assistance system according to an exemplary embodiment encompasses a control unit, such as a microprocessor, an environmental sensor, such as an electronic camera or radar device, for detecting moving or stationary obstacles, such as other vehicles, pedestrians, etc., on a road in front of a vehicle, which the driver assistance system has on board, as well as an actuator for activating the brakes of a vehicle and/or a signaling device for generating an acoustic, optical or haptic warning signal, which can alert the driver of a vehicle to a danger detected by the assistance system. Since driver assistance systems with these components are known in the art, they need not be explained in any detail at this juncture.

In addition, in an embodiment, the control unit of the driver assistance system is connected with a foot sensor for detecting movements of the driver's feet, or the foot he or she uses to press the gas pedal and brake pedal.

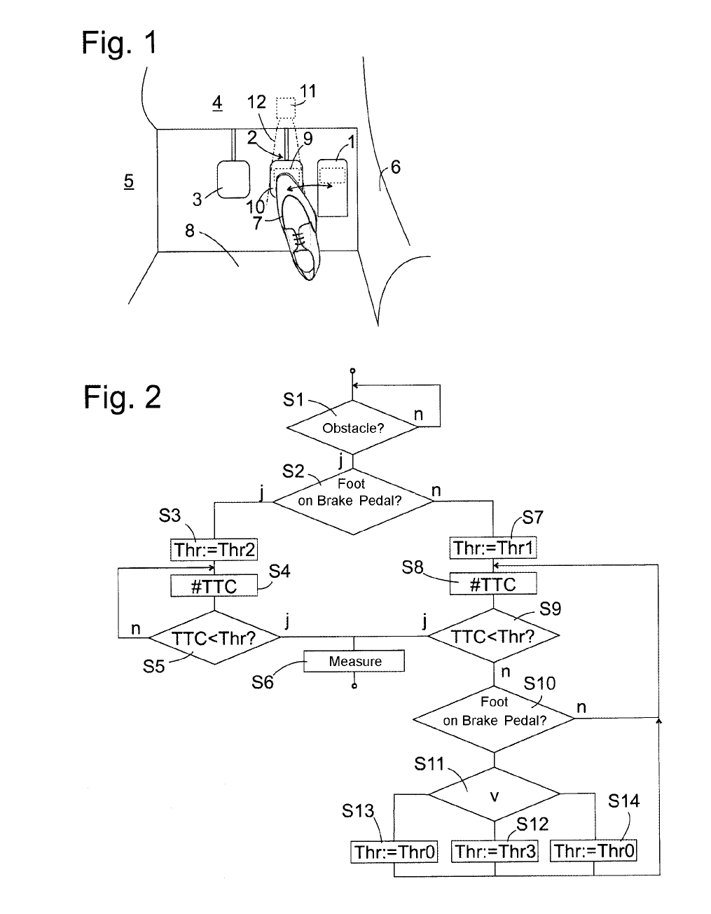

FIG. 1 shows a schematic view of the foot well in front of the driver's seat of a motor vehicle. A gas pedal 1, brake pedal 2, and an optional clutch pedal 3 are arranged in a niche below a dashboard 4 in the usual manner. The sides of the niche are bordered by a driver's door 5 and a transmission tunnel 6.

A foot 7 of a driver rests with its heel against a floor plate 8 of the foot well. The gas pedal 1 and brake pedal 2 are placed next to each other closely enough that the foot 7 can switch from one pedal 1 or 2 to the other in a pivoting motion as denoted by a double arrow on the figure, without lifting the heel from the floor plate 8.

The aforementioned foot sensor can be an infrared, ultrasound or capacitive sensor 9, which is mounted in a footboard 10 of the brake pedal 2, and is able to detect the foot 7 of the driver in its position depicted on FIG. 1 in a contactless manner at a distance of up to several centimeters away from the brake pedal 2, but without responding when the foot 7 is located in front of an adjacent pedal 1 or 3.

A camera 11, preferably an infrared camera, can alternatively or additionally be mounted in the dashboard 4 in such a way that its viewing field 12—bordered by dot-dashed lines on the figure—encompasses the air space right in front of the footboard 10 of the brake pedal 2. The camera 11 is depicted with dashed lines on FIG. 1, since it is itself not visible in the perspective given on the figure; the only exposed part of the camera 11 is an entry lens on the underside of the dashboard.

In some embodiments, a foot sensor 13 of the same type as the foot sensor 9 is also secured to the gas pedal 1, or the camera 11 is mounted in such a way that its viewing field encompasses the air space both in front of the brake pedal 2 and the gas pedal 1.

Examples of possible operating modes for the control unit of the driver assistance system will be explained with reference to the flowchart on FIG. 2. In a first procedural step S1, in accordance with an exemplary embodiment, the control unit evaluates the data supplied by the environmental sensor, so as to decide whether an obstacle is in the way of the vehicle. As long as no obstacle is detected, the process is limited to periodically repeating this search S1. For example, the presence of an obstacle can be confirmed in step S1 when a vehicle in front or a pedestrian is suddenly in the detection range of the environmental sensor after driving around a bend, or when a minimum distance to an obstacle that has already been in the detection range of the environmental sensor for some time is undershot.

In step S2, the control unit uses information delivered based on the foot sensor 9 or camera 11 to decide whether the right foot 7 of the driver is on or in front of the brake pedal 2, so that the driver could decelerate by simply extending his or her foot 7 if so desired. In a vehicle with manual transmission and clutch, the presence of the left foot of the driver on the clutch pedal 3 can be drawn upon as an additional criterion, since decelerating quickly without stalling the engine requires that the clutch pedal 3 also be pressed at the same time. To this end, the clutch pedal 3 can also be equipped with a sensor of the same type as sensor 9, or the viewing field of the camera 11 encompasses the air space in front of the clutch pedal 3 as well, and the control unit is suitably programmed to use images supplied by the camera 11 in determining which pedal 1, 2, 3 a respective foot 7 is located in front of, if any.

Therefore, in an embodiment, if at least the presence of one foot on the brake pedal 2 and possibly the other foot on the clutch pedal 3 indicates that the driver is prepared to brake, the control unit selects a medium response threshold Thr2 in step S3, estimates the distance from the obstacle and speed of the vehicle relative to the obstacle in step S4, and calculates a residual time TTC remaining until a possible collision with the obstacle based on these data. As long as the latter is greater than the threshold Thr2 set in step S3, the process returns to S4, thereby continuously updating the residual time TTC. If the paths of the vehicle equipped with the driver assistance system and a vehicle in front detected as the obstacle diverge, or if the distance between the vehicles increases, so that the vehicle in front is no longer detected as an obstacle, the process is discontinued with respect to this vehicle. By contrast, if the residual time TTC drops below the threshold Thr2, a protective measure is introduced in step S6, which can involve applying the brakes of the vehicle or generating a warning signal that prompts the driver to press on the brakes.

If it is determined in step S2 that the foot 7 is not located on the brake pedal 2, in an embodiment, a numerically higher threshold Thr1 than in step S3 is set in step S7, which is tantamount to an elevated sensitivity of the assistance system. The residual time is calculated and compared with the threshold in step S9 in the exact same way as described with respect to steps S4, S5. Here as well, the process branches to step S6 if the residual time TTC drops below the threshold Thr1. In this instance, the higher sensitivity takes into account the fact that the driver, in order to brake, needs time to place the foot on the brake pedal, and that, if he or she does not place a foot on the brake pedal despite the lower residual time TTC, this strongly indicates that the driver is lacking in attentiveness, and thus that the measure in step S6 is necessary.

If it is determined in step S9 that the residual time TTC has not yet dropped below the set threshold Thr1, in an embodiment, the residual time TTC is regularly updated as in the case of step S5. During these updates, it is respectively checked in step S10 whether the driver might in the meantime have placed his or her foot on the brake pedal. Should this not be the case, the process returns to step S8. By contrast, if the driver has placed his or her foot on the brake pedal, this clearly indicates that he or she is attentively following the traffic conditions, and will be able to brake in time if it becomes necessary. For this reason, the threshold Thr is here reduced to a numerical value Thr3 that is less than or equal to Thr2, i.e., the residual time TTC can drop down to the value Thr3 before safety measure S6 is implemented.

In a further embodiment of the method, yet another step S11 takes place between steps S10 and S12, in which the control unit estimates the speed at which the driver is moving his or her foot, e.g., based on a movement detected by the camera 11 or the time elapsed between when the foot 7 stops being detected by foot sensor 13 and starts being detected by foot sensor 9, and compares this speed with two limiting values. In this embodiment of the method, the threshold Thr3 is only set if the first speed lies between the two limiting values. In both the case of an extremely slow, possibly random movement, as well as an extremely fast, possibly startle-induced movement, a numerically high threshold Thr0 is set (S13, S14), which the residual time TTC will drop below with a high probability, so that branching to safety measure S6 takes place immediately during the next repetition of step S9.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A driver assistance system of a motor vehicle comprising:
a foot sensor configured for monitoring a driver's foot;
a control unit configured for deciding on a safety measure based on a detection result of the foot sensor;
an environmental sensor configured to detect an approach toward an outside obstacle and to only implement the safety measure if a detection result of the environmental sensor indicates a danger that contact will be made with the outside obstacle.

2. The driver assistance system according to claim 1, wherein the control unit is configured to quantitatively assess a risk of contact with the outside obstacle based on the detection result of the environmental sensor, and to implement the safety measure at a prescribed risk level when the detection result of the foot sensor indicates that a driver is unprepared to brake, and to forego the safety measure if the foot sensor indicates that the driver is prepared to brake.

3. The driver assistance system according to claim 1, wherein the foot sensor is configured for contactless detection of a body in an air space in front of a tread of a brake pedal of the motor vehicle.

4. The driver assistance system according to claim 3, wherein the foot sensor comprises a camera facing the air space in front of the tread.

5. The driver assistance system according to claim 4, wherein the foot sensor comprises an infrared camera or a contactless sensor mounted on the brake pedal.

6. The driver assistance system according to claim 5, wherein the foot sensor comprises the contactless sensor mounted on the tread of the brake pedal.

7. The driver assistance system according to claim 5, wherein the contactless sensor is an infrared sensor, an ultrasound sensor, or a capacitive sensor.

8. The driver assistance system according to claim 1, wherein a limiting value above which the control unit initiates the safety measure varies depending on the detection result of the foot sensor.

9. The driver assistance system according to claim 1, wherein the safety measure involves activating brakes of the motor vehicle or outputting a warning signal to a driver.

10. The driver assistance system according to claim 1, wherein the control unit is configured to assume that a driver is more prepared to brake if the foot sensor detects a body than if it detects no body.

11. The driver assistance system according to claim 1, wherein the control unit is configured to assume that a driver is more prepared to brake if the foot sensor begins detecting a body only after detecting the outside obstacle than if it already detected the body before beginning to detect the outside obstacle.

12. The driver assistance system according to claim 1, wherein the foot sensor is configured to estimate a speed a body is moving, and evaluate braking preparedness based on the speed.

13. The driver assistance system according to claim 1, wherein the foot sensor or an additional sensor is configured to detect a body in front of a clutch pedal and wherein the control unit assumes a higher braking preparedness if a body is also detected on the clutch pedal at the same time as a body is detected on a brake pedal than if a body is detected only on the brake pedal.
